(19) United States
(12) Patent Application Publication
(10) Pub. No.: US 2026/0179079 A1
(43) Pub. Date: Jun. 25, 2026

(54) SYSTEMS AND METHODS OF CONTACTLESS CARD AS ONE AUTHENTICATION FACTOR FOR MULTIPLE FACTOR AUTHENTICATION

(71) Applicant: Capital One Services, LLC, McLean, VA (US)

(72) Inventors: Katherine McHUGH, Richmond, VA (US); Lesley NEWTON, Richmond, VA (US); Patrick ZEARFOSS, Leesburg, VA (US)

(21) Appl. No.: 19/536,712

(22) Filed: Feb. 11, 2026

Related U.S. Application Data
(63) Continuation of application No. 18/120,236, filed on Mar. 10, 2023, now Pat. No. 12,591,875.

(51) Int. Cl. G06Q 20/34; G06Q 20/40

(52) U.S. Cl. CPC G06Q 20/352; G06Q 20/401

(57) ABSTRACT

Systems and methods for authenticating a user using a contactless card as one authentication factor for multiple factor authentication are provided. In an exemplary embodiment, a server receives a first request of authenticating a user using a first authentication factor, authenticates the user using the first authentication factor, and receives a second request of authenticating the user using a contactless card as a second authentication factor. The server receives a cryptogram of the contactless card, validates the cryptogram, decrypts the cryptogram, and extracts a unique customer identifier of the contactless card. The server verifies the unique customer identifier, authenticates the user using the unique customer identifier, and transmits an authentication result of authenticating the user using the contactless card as the second authentication factor.

### CROSS-REFERENCE TO RELATED APPLICATION

The present application is a continuation of U.S. patent application Ser. No. 18/120,236, filed Mar. 10, 2023, the contents of which are hereby incorporated by reference in their entirety.

### FIELD OF THE INVENTION

The present disclosure relates generally to data security, and more particularly, to systems and methods for authenticating a user using a contactless card as one authentication factor for multiple factor authentication.

### BACKGROUND

Data security and transaction integrity are of critical importance to businesses and consumers. Customers are usually authenticated using multiple factors when transactions are being conducted. Email may be used as one authentication factor to verify customers and/or transactions, but email is susceptible to attack and vulnerable to hacking or other unauthorized access. Short message service (SMS) messages may also be used, but that is subject to compromise as well.

When customers conduct high risk transactions, such as activating financial cards (e.g., credit cards and other payment cards), revealing digital financial cards, and so forth, multiple factor authentication including one secure factor is highly desired. Although a photo identification (ID) (e.g., a government-issued ID) can be presented as a second authentication factor, it does not work or is inconvenient for online transactions or other transaction that are not conducted face-to-face.

These and other deficiencies exist. Accordingly, there is a need to provide systems and methods that overcome these deficiencies to authenticate a user using a more secure factor, such as a contactless card, as one authentication factor for multiple factor authentication.

### SUMMARY

Aspects of the disclosed technology include systems and methods of authenticating a user using a contactless card as one authentication factor for multiple factor authentication.

Embodiments of the present disclosure provide a method for authenticating a user using a contactless card as a second authentication factor. The method comprises: receiving, by a server from a first device, a first request of authenticating the user using a first authentication factor; authenticating, by the server, the user using the first authentication factor; transmitting, by the sever to the first device, a first authentication result of authenticating the user using the first authentication factor; receiving, by the server from the first device, a second request of authenticating the user using the contactless card as the second authentication factor; transmitting, by the server to a user device associated with the user, the second request in a message format; receiving, by the server from the user device, a cryptogram of the contactless card; validating, by the server, the cryptogram; decrypting, by the server, the cryptogram; extracting, by the server, from the decrypted cryptogram a unique customer identifier of the contactless card; verifying, by the server, the unique customer identifier; authenticating, by the server, the user using the unique customer identifier; and transmitting, by the sever to the first device, a second authentication result of authenticating the user using the contactless card as the second authentication factor.

Embodiments of the present disclosure provide a system for authenticating a user using a contactless card as a second authentication factor. The system comprises a server, and the server is configured to: receive, from a first device, a first request of authenticating the user using a first authentication factor; authenticate the user using the first authentication factor; transmit, to the first device, a first authentication result of authenticating the user using the first authentication factor; receive, from the first device, a second request of authenticating the user using the contactless card as the second authentication factor; transmit, to a user device associated with the user, the second request in a message format; receive, from the user device, a cryptogram of the contactless card; validate the cryptogram; decrypt the cryptogram; extract from the decrypted cryptogram a unique customer identifier of the contactless card; verify the unique customer identifier; authenticate the user using the unique customer identifier; and transmit, to the first device, a second authentication result of authenticating the user using the contactless card as the second authentication factor.

Embodiments of the present disclosure provide a non-transitory, computer-readable medium comprising instructions for authenticating a user using a contactless card as a second authentication factor that, when executed on a computer arrangement, perform actions comprising: receiving, from a first device, a first request of authenticating the user using a first authentication factor; authenticating the user using the first authentication factor; transmitting, to the first device, a first authentication result of authenticating the user using the first authentication factor; receiving, from the first device, a second request of authenticating the user using the contactless card as the second authentication factor; transmitting, to a user device associated with the user, the second request in a message format; receiving, from the user device, a cryptogram of the contactless card; validating the cryptogram; decrypting the cryptogram; extracting from the decrypted cryptogram a unique customer identifier of the contactless card; verifying the unique customer identifier; authenticating the user using the unique customer identifier; and transmitting, to the first device, a second authentication result of authenticating the user using the contactless card as the second authentication factor.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for authenticating a user using a contactless card as a second authentication factor according to an example embodiment.

FIG. 2 is a diagram of sequential interactions between components of the system in FIG. 1 according to an example embodiment.

FIG. 3A is a contactless card used for authenticating a user as a second authentication factor according to an example embodiment.

FIG. 3B is a diagram of the processor of the contactless card in FIG. 3A according to an example embodiment.

FIG. 4 is a flow chart of a method for authenticating a user using a contactless card as a second authentication factor according to an example embodiment.

FIG. 5 is a flow chart of a method for authenticating a user using a contactless card as a second authentication factor according to an example embodiment.

FIG. 6 is a flow chart of a method for authenticating a user using a contactless card as a second authentication factor according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments should facilitate understanding of the invention to such an extent that other implementations, not specifically covered but within the knowledge of a person of skill in the art having read the description of embodiments, will be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

Example embodiments of the present disclosure provide systems and methods for authenticate a user using a contactless card as one authentication factor for multiple factor authentication. The present invention allows a user to use something he or she has with a contactless card to complete a high risk authentication transaction via a channel and/or space that does not allow for near field communication (NFC) usage. As such, the user can log in his/her account (something he or she knows) in a different channel while having a NFC-enabled device (such as a mobile phone) that can read the contactless card as a second authentication factor for the multiple factor authentication.

An improved customer experience may include allowing a contactless card to be used either with or without another login (e.g., login into a banking application for reading the contactless card) to ease on a device, such as an Android® instant application, a post auth session on an iOS® application, a push notification with a long press, and tapping the contactless card in a drop down action as part of same experience. The NFC session may launch within the banking application context itself, or may be launched directly in response to the notification received on the device.

In the present disclosure, a contactless card can be used as an authentication method that can be instantiated as an out of band or second factor authentication in scenario where a user could be doing the primary action (e.g., a high risk transaction like a digital card reveal) on web, tablet, non-NFC based device, call center, interactive voice response (IVR), Capital One® ENO® virtual assistant, a bank branch, or any other channels used for customer servicing. The interaction with the contactless card can be initiated on a NFC-enabled mobile device using communications such as SMS with deeplink, mobile application notifications, push notification, email, or any other channel that can be received on a user device.

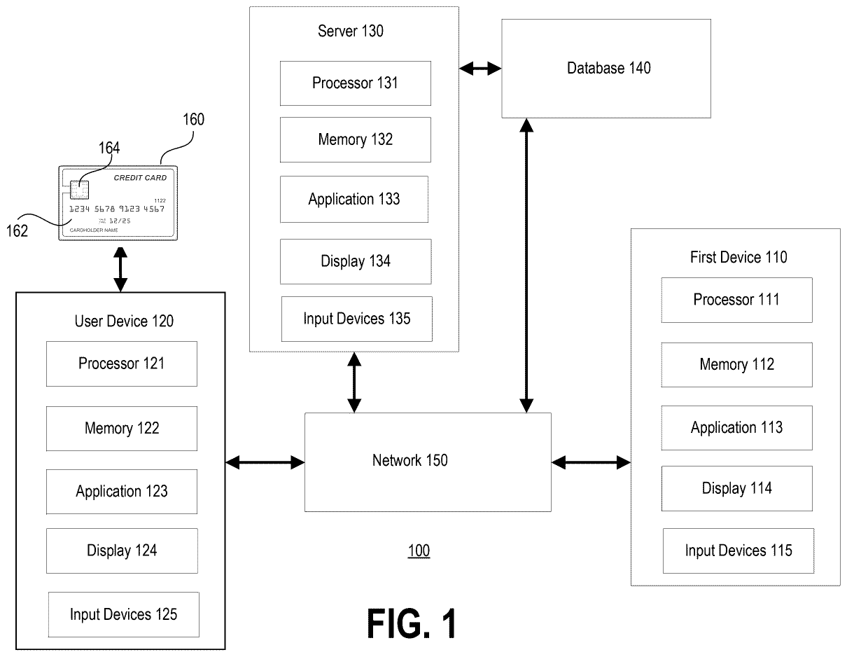

FIG. 1 illustrates a system 100 for authenticating a user using a contactless card as a second authentication factor for multiple factor authentication according to an example embodiment. As further discussed below, the system 100 may include a first device 110, a user device 120, a server 130, a database 140 in communication using a network 150, and a contactless card 160 in signal communication with the user device 120. Although FIG. 1 illustrates single instances of the components, the system 100 may include any number of components.

The first device 110 may be associated with a merchant with which the transactions are conducted by the user through the user device 120, for example, online purchases made from the merchant. The first device 110 may also be associated with a call and/or service center to which the user may make a call to initiate a transaction such as discussing product and/or service issues. The first device 110 may further be associated with a bank branch in which the user may conduct an transaction and interact with a bank employee. If the first device 110 is associated with a merchant, the first device 110 can be configured to store the online merchant accounts, and to present a shopping interface on which the user can conduct the transactions with the merchant.

The first device 110 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. For example, the application 113 may be executed to perform authenticating the user or send an authentication request of authenticating the user to the server 130. The application 113 may also be executed to perform processing transactions of a user who may shop online from the merchant. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, touch-screen, microphone, digital camera, video recorder or camcorder. These devices may be used to enter information and interact with the software and other devices described herein.

The user device 120 can be used by a user to initiate and/or perform transactions with the first device 110, for example, a call to a customer service center associated with the first device 110. The user device 120 may be configured to present to the user a user interface from which the user may log into, for example, their bank or credit card account to access their transaction statement and/or financial information stored in the database 140 of the server 130. The user interface may also be configured to perform data communication with the contactless card 160. The user device 120 may be configured to display on the user interface a merchant's website, in response to a selection by the user of accessing the merchant's website.

The user device 120 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, an application 123, a display 124, and input devices 125. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the merchant.

The server 130 may be associated with an institution, such as a financial institution, and can be configured to communicate with the first device 110 and the user device 120. The institution associated with the server 130 may issue the contactless card 160 to the user and accordingly may authenticate the user based on the contactless card 160.

The server 130 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the card authentication module of the application 133 may be executed to perform authenticating the user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the user device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and user device 120 using the network 150 can occur using one or more front channels and one or more secure back channels. A front channel may be a communication protocol that employs a publicly accessible and/or unsecured communication channel such that a communication sent to the first device 110, server 130, and/or user device 120 may originate from any other device, whether known or unknown to the first device 110, server 130, and/or user device 120, if that device possesses the address (e.g., network address, Internet Protocol (IP) address) of the first device 110, server 130, and/or user device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or user device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to the user by the financial institution for identity verification for the bank account of the user

The contactless card 160 can be configured to transmit a cryptogram to the user device 120 upon tapping to the user device 120. The user device 120 may be configured to read the cryptogram from the contactless card 160 after entry of the contactless card 160 into a communication field of the user device 120. The user device 120 may then transmit the cryptogram to the server 130. The server 130 may be configured to verify the cryptogram by searching the database 140.

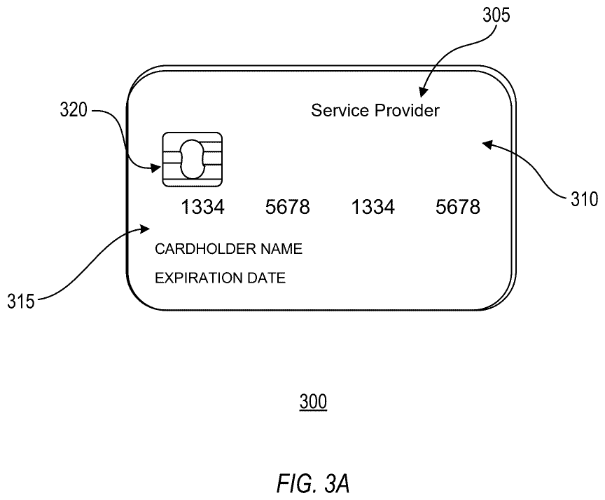

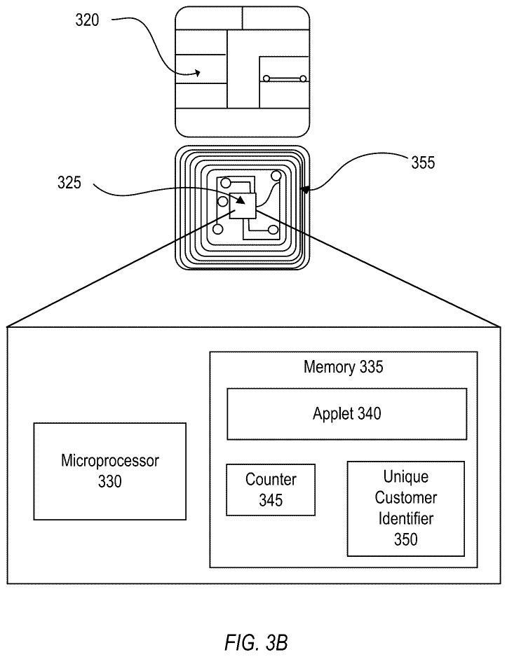

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone or the user device 120) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3A and 3B.

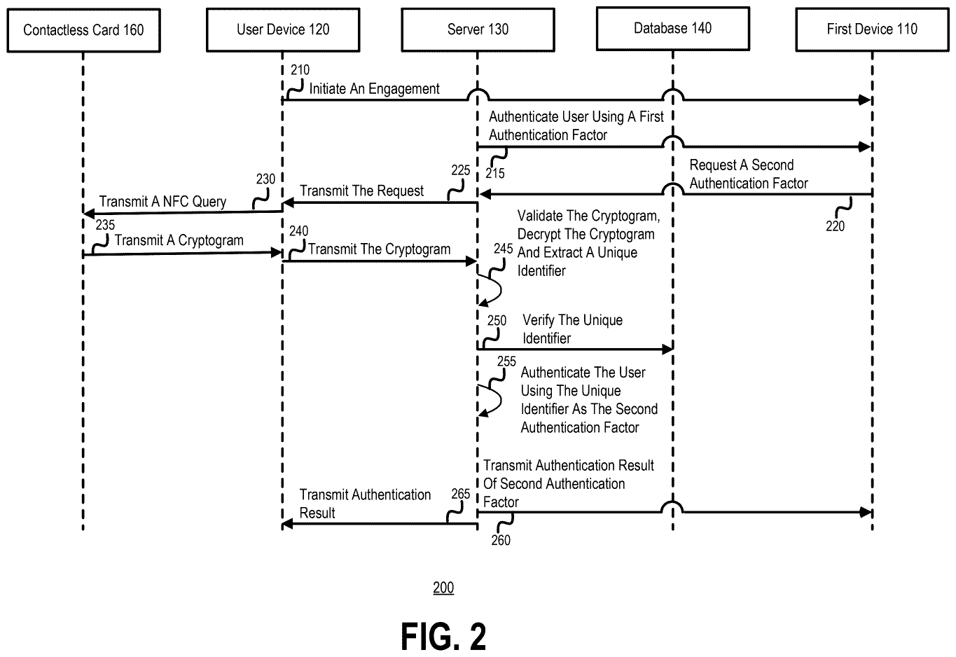

FIG. 2 illustrates an example diagram 200 of sequence interaction between the components of the system 100 according to an example embodiment. FIG. 2 may reference the same or similar components as those illustrated in FIG. 1, including a user device, a server, a database, a first device and a contactless card.

When a user wants to make an online purchase from a merchant, the user may use the user device 120 to log into his/her online account with the merchant is associated with the first device 110. Alternatively, the user may call using the user device 120 to a customer service center that is associated with the first device 110. In those example embodiments, the user using the user device 120 initiates an engagement with the first device 110 at step 210.

Upon receiving the login credentials or the phone call from the user device 120, the first device 110 may transmit a first authentication request to the server 130 for authenticating the user. Accordingly, the server 130 may authenticate the user using a first authentication factor at step 215. The first authentication factor may the login credential or the phone number associated with the user device 120. For example, the first device 110 may forward the login credential or the phone number to the server 130, and the server 130 may then search for and verify the login credential or the phone number in the database 140.

To further authenticate the user or perform a multiple factor authentication of the user, the first device 110 may request a second authentication factor for authenticating the user and transmit the request to the server 130 at step 220. For example, the second authentication factor may be a contactless card, such as the contactless card 160.

At step 225, the server 130 may transmit the request of using the contactless card 160 as the second authentication factor to the user device 120. The request may be a short message service (SMS) message with a link that would open up a mobile app or mobile app process on the user device 120 from which the contactless card 160 can be read in that mobile app.

Upon receiving the request and by clicking on the link included in the request, the user may use the user device 120 to transmit an NFC prompt and/or query to the contactless card 160 at step 230. The user device 120 may include an NFC interface configured for establishing an NFC communication with other NFC-equipped devices (the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits, at step 235 to the user device 120 NFC response information (e.g., a cryptogram) usable by the server 130 to authenticate the user. The NFC response information may be or include, for example, security information encrypted by the contactless card 160 using a private key unique to the card that is known only to the card account administrator (the server 130). The cryptogram may be stored in the memory of the contactless card 160. The cryptogram includes the unique identifier of the contactless card 160.

At step 240, the user device 120 transmits the NFC response information (the cryptogram) the server 130. At step 245, the server 130 receives the cryptogram from the user device 120. The server 130 validates the cryptogram, decrypts the cryptogram and extracts the unique identifier of the contactless card 160 through the card authentication module of the server 130. When the server receives the cryptogram, the server may decrypt the cryptogram after verifying the cryptogram. The server 130 may then extract the unique identifier of the contactless card 160 which is uniquely associated with the user. At step 250, the server 130 may verify the unique identifier of the contactless card 160 by searching the database 140. Then at step 255, the server 130 may authenticate the user based on the unique identifier of the contactless card 160. That is, the server 130 may authenticate the user using the contactless card 160 as the second authentication factor based on the unique identifier of the contactless card 160.

In some embodiments, the server 130 may also require the user to enter a personal identification code/number (PIN) as a third authentication factor. Alternatively, the server 130 may require the user to enter a one-time passcode (OTP) as a third authentication factor that is randomly generated and transmitted by the server 130 to the user device 120 in a text message.

At step 255, the server 130 may transmit to the first device 110 the authentication result of using the contactless card 160 as the second authentication factor. Also the server 130 may transmit to the user device 120 the authentication result of using the contactless card 160 as the second authentication factor. Once the user is authenticated using the contactless card 160 as the second authentication factor, the user can continue the initiated transaction with the first device 110 through the user device 120.

As described above, when a user uses a user device to initiate an event or transaction with another device, the user can be directed to use a mobile app installed on the user device to read a contactless card for authenticating the user as a second factor for multiple factor authentication. For example, the user may make a call to a call center because the user is having a problem with his/her account, to verify the user, an SMS with a link that would open up a mobile app or mobile app process can be transmitted to the user through the user device and the user would be able to read the contactless card in that mobile app and then that contactless card data would go back to the call center agent and/or server, so the call center would be able to verify the user is using his/her contactless card to do this extra verification step. As another example, the user may be just logging in on a website, and the channel (e.g., the website) then switches the user to the mobile app on the user device to do this extra verification step. As a further example, the user may visit a local bank branch which can trigger a similar process, where the user can be switched over to his/her mobile phone for the contactless card tap as a second authentication factor of identity confirmation.

The first factor may include username and password, and a biometric login (such as a touch ID (e.g., a fingerprint ID), face ID, retina ID, voice ID). In the present disclosure, the first factor may also include a phone number of the user, a check or saving account number of the user, a photo ID of the user (such as driver's license of the user). For example, when the user call the call center, the phone number of the user can be recognized as the first factor for authenticating the user. When the user is in a bank branch and a teller or a bank associate is pulling up details of the user, the driver's license of the user may be used as the first factor for authenticating the user. When a second authentication factor is needed, the teller or the bank associate may just watch the user to tap the contactless card to the user device 120 of the user as the second factor. Alternatively, a link with a deep links may be transmitted into the mobile app of the user device 120, and the user can follow the link to tap the contactless card. In such scenarios, the user does not have to fully log in the mobile app installed on the user device 120. The user just taps the contactless card to the user device 120 and the server 130 is going back to inform that call center agent or that teller in the bank branch.

FIG. 3A describes a contactless card 300 that can be used for authenticating the user as a second authentication factor in the system 100 of FIG. 1. For example, the contactless card 160 in FIG. 1 can be the contactless card 300 described herein. The contactless card 300 is configured to communicate with the user device 120 of system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity/CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the memory 335. In various embodiments, the memory 335 may have stored therein instructions for generating encrypted information and transmitting it to a receiving device (e.g., the user device 120). Such encrypted information may be or include an encrypted verification block or signature that may be used to authenticate and verify the presence of the card 300 during transaction processing. In some embodiments, encrypted information may be unique to a particular communication (e.g., a particular NFC transmission by the card 300).

The memory 335 may be configured to store one or more applets 340, one or more counters 345, and a unique customer identifier 350. The one or more applets 340 may comprise one or more software applications configured to execute on one or more contactless cards, such as Java Card applet. However, it is understood that the one or more applets 340 are not limited to Java Card applets, and instead may be any software application operable on contactless cards or other devices having limited memory. The one or more counters 345 may comprise a numeric counter sufficient to store an integer. The unique customer identifier 350 may comprise a unique alphanumeric identifier assigned to a user of the contactless card 300, and the identifier may distinguish the user of the contactless card 300 from other contactless card users. In some examples, the customer identifier 350 may identify both a customer and an account assigned to that customer and may further identify the contactless card 300 associated with the customer's account.

The processor 330 and memory 3335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the user device 120) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more or more applications or applets (applet 340) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader (the user device 120), and produce an NDEF message that comprises a cryptographically secure OTP encoded as an NDEF text tag.

The contactless card 300 may be configured for communication with the user device 120 via a communication interface configured for establishing communication with the user device 120. The communication interface may be configured for contact-based communication, in which case the interface may have electrical circuitry and contact pads on the surface of the card 300 for establishing direct electrical communication between the card 300 and the user device 120. Alternatively or in addition, the communication interface may be configured for contactless communication with the user device 120. In such embodiments, the communication interface may be or include an NFC communication interface configured for communication with other NFC communication devices when the card 300 is within a predetermined NFC range. In some embodiments, the card 300 may include a second communication interface configured for establishing short range communication with the user device 120 via Bluetooth, or other short range communication methodology. In such embodiments, the card 300 may have a short range communication antenna that is included in or connected to the short range communication interface. The card 300 may also include a power management system for use in managing the distribution of power during an NFC transaction.

The contactless card 300 can be configured to transmit a cryptogram to the user device 120 upon tapping to the user device 120. The user device 120 may be configured to read the cryptogram from the contactless card 300 after entry of the contactless card 300 into a communication field of the user device 120. The user device 120 may then transmit the cryptogram to the server 130. The server 130 may be configured to verify the cryptogram by searching the database 140.

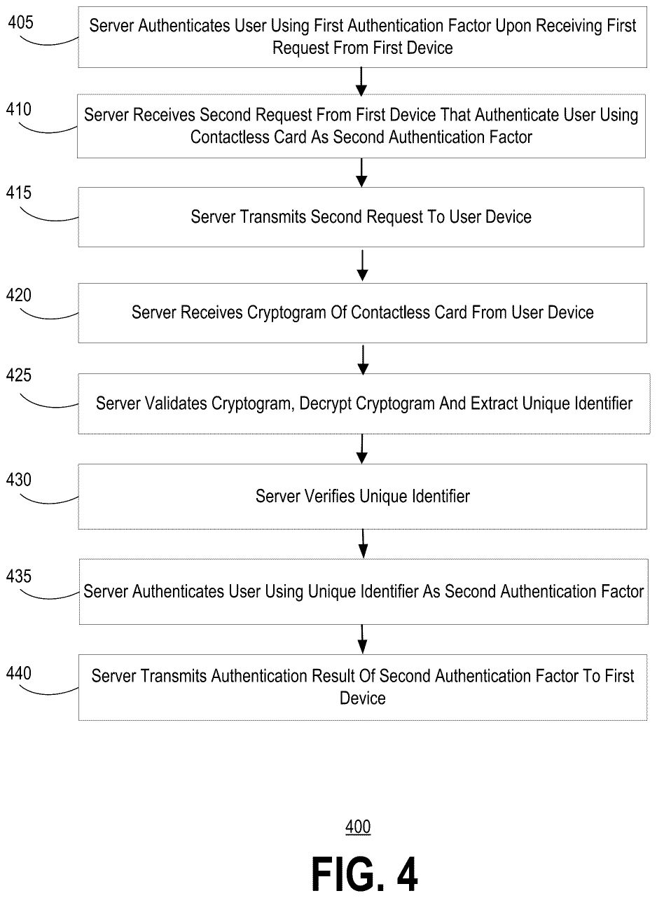

FIG. 4 illustrates a flow chart of an example method 400 for authenticating a user using a contactless card as a second authentication factor for multiple factor authentication according to an example embodiment. FIG. 4 may reference the same or similar components as those illustrated in FIGS. 1-3, including a user device, a server, a database, a first device, and a contactless card. The method 400 can be implemented in the system 100 and may include, but is not limited to the following steps.

When a user wants to make an online purchase from a merchant, the user may use the user device 120 to log into his/her online account with the merchant is associated with the first device 110. Alternatively, the user may call using the user device 120 to a customer service center that is associated with the first device 110. In those example embodiments, the user using the user device 120 initiates an engagement with the first device 110. Upon receiving the login credentials or the phone call from the user device 120, the first device 110 may transmit a first authentication request to the server 130 for authenticating the user. Accordingly, at step 405, the server 130 may authenticate the user using a first authentication factor upon receiving the first request from the first device 110. The first authentication factor may the login credential or the phone number associated with the user device 120. For example, the first device 110 may forward the login credential or the phone number to the server 130, and the server 130 may then search for and verify the login credential or the phone number in the database 140.

To further authenticate the user or perform a multiple factor authentication of the user, the first device 110 may request a second authentication factor for authenticating the user and transmit the request to the server 130. For example, the second authentication factor may be a contactless card, such as the contactless card 160/300. Accordingly, at step 410, the server 130 receives the second request from the first device 110 that authenticates the user using the contactless card as the second authentication factor.

At step 415, the server 130 may transmit the second request of using the contactless card 160/300 as the second authentication factor to the user device 120. The second request may be a short message service (SMS) message with a link that would open up a mobile app or mobile app process on the user device 120 from which the contactless card 160/300 can be read in that mobile app.

Upon receiving the second request and by clicking on the link included in the request, the user may use the user device 120 to transmit an NFC prompt and/or query to the contactless card 160/300. In response, after entry of the contactless card 160/300 into the NFC communication field of the user device 120, the contactless card 160/300 transmits to the user device 120 NFC response information (e.g., a cryptogram) usable by the server 130 to authenticate the user. The NFC response information may be or include, for example, security information encrypted by the contactless card 160/300 using a private key unique to the card that is known only to the card account administrator (the server 130). The cryptogram may be stored in the memory of the contactless card 160/300. The cryptogram includes the unique identifier of the contactless card 160/300.

The user device 120 transmits the NFC response information (the cryptogram) the server 130. At step 420, the server 130 receives the cryptogram from the user device 120. The server 130 validates the cryptogram, decrypts the cryptogram and extracts the unique identifier of the contactless card 160/300 through the card authentication module of the server 130 at step 425. When the server receives the cryptogram, the server may decrypt the cryptogram after verifying the cryptogram. The server 130 may then extract the unique identifier of the contactless card 160/300 which is uniquely associated with the user. At step 430, the server 130 may verify the unique identifier of the contactless card 160/300 by searching the database 140. Then at step 435, the server 130 may authenticate the user based on the unique identifier of the contactless card 160/300. That is, the server 130 may authenticate the user using the contactless card 160/300 as the second authentication factor based on the unique identifier of the contactless card 160/300.

In some embodiments, the server 130 may also require the user to enter a personal identification code/number (PIN) as a third authentication factor. Alternatively, the server 130 may require the user to enter a one-time passcode (OTP) as a third authentication factor that is randomly generated and transmitted by the server 130 to the user device 120 in a text message.

At step 440, the server 130 may transmit to the first device 110 the authentication result of using the contactless card 160/300 as the second authentication factor. Also the server 130 may transmit to the user device 120 the authentication result of using the contactless card 160/300 as the second authentication factor. Once the user is authenticated using the contactless card 160/300 as the second authentication factor, the user can continue the initiated transaction with the first device 110 through the user device 120.

In some embodiment, the user device 120 may be a device associated with an entity of the first device 110. For example, when the user visits a bank branch or a merchant store, the user may be required to tap the contactless card to a device installed in that bank branch or the merchant store. That device installed in the bank branch or the merchant store may include an iOS® or Android® device, a point of sale device, a terminal, or a kiosk.

In some embodiments, the user device 120 receives a push notification of using the contactless card as the second authentication factor. The user may tap it and hold his/her finger down for a relatively long duration, which opens up an immediate capability for the user to tap the contactless card quicker. This can remove another step or more friction or time to allow the user to take action more quickly.

In some embodiments, the user may be required to log in the mobile app installed on the user device for reading the contactless card, such as face ID. In some other embodiments, the user may not be required to log in the mobile app installed on the user device for reading the contactless card.

In some embodiments, the transaction or event may occur between the user device 120 and an interactive voice response (IVR) device and/or system. For example, the user may use the user device 120 to call in to the IVR system, punches selections and input initial information that is required to identify who they are by following the prompts. Then the user can trigger, based on the task or the action they want to take on the IVR system, a push notification to go to the user device 120, and that push notification would open up a contactless card tap for the second authentication factor. The systems and methods disclosed herein can use the second authentication factor to allow the user to take or perform a more risky transaction. This can open up an avenue that instead of that call needing to go to a physical agent, the user could keep it within that IVR experience, which can prevent call volume from hitting the agent queues.

In some embodiments, the transaction or event may occur between the user device 120 and a web assistant. For example, the user may be visiting in the browser, or talking to a smart device, which can allow to initiate an action via email to complete the authentication of using the contactless card as the second authentication factor.

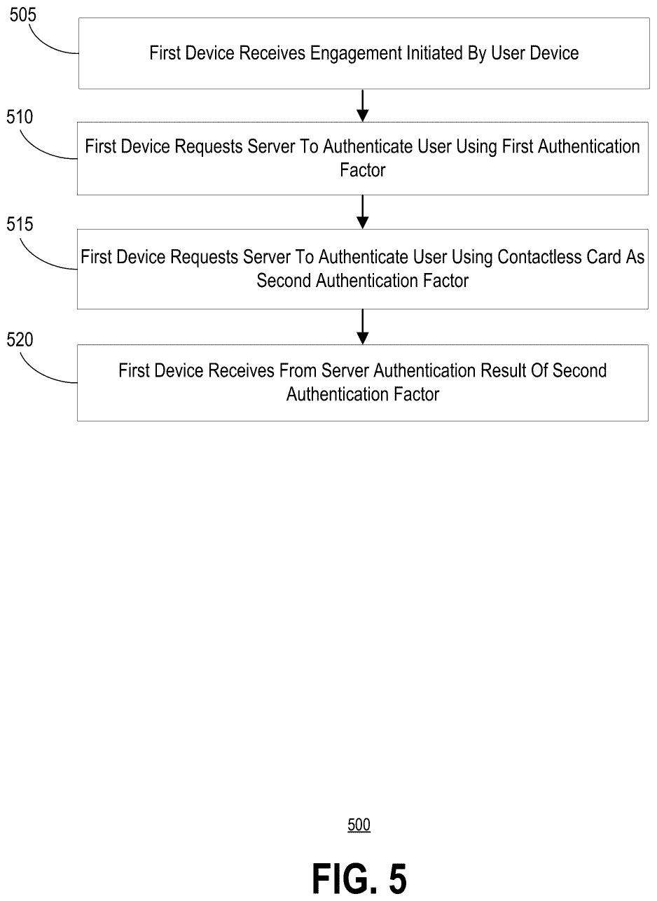

FIG. 5 illustrates a flow chart of an example method 500 for authenticating a user using a contactless card as a second authentication factor for multiple factor authentication according to an example embodiment. FIG. 5 may reference the same or similar components as those illustrated in FIGS. 1-4, including a user device, a server, a database, a first device, and a contactless card. The method 500 can be implemented in the system 100 and may include, but is not limited to the following steps.

The method 500 may be implemented on the first device 110. The first device 110 is associated with an entity with whom the user initiates a transaction, such as a call center, a bank branch, a local merchant store, and the like. In step 505, the first device 110 receives an engagement initiated from the user device 120 associated with a user. For example, the first device 110 receives a phone call made by the user from the user device 120. In step 510, the first device 110 requests the server 130 to authenticate the user using a first authentication factor. The first authentication factor may be a phone number of the user device 120. The first device 110 can transmit the phone number of the user device 120 to the server 130, and the server 130 can verify the phone number by searching the database 140 for a matching phone number associated with the user. In step 515, the first device 110 requests the server 130 to authenticate the user using a contactless card as a second authentication factor. For example, once the user is authenticated with the first authentication factor, the first device 110 may require a second authentication factor for further verifying the user, and accordingly, transmits a second authentication request to the server 130 for authenticating the user using a contactless card as the second authentication factor. In step 520, the first device 110 receives from the server 130 the authentication result of the second authentication factor. For example, when the server 130 verifies the user using the contactless card 160/300 as the second authentication factor, the server 130 can transmit to the first device 110 the authentication result of the second authentication factor.

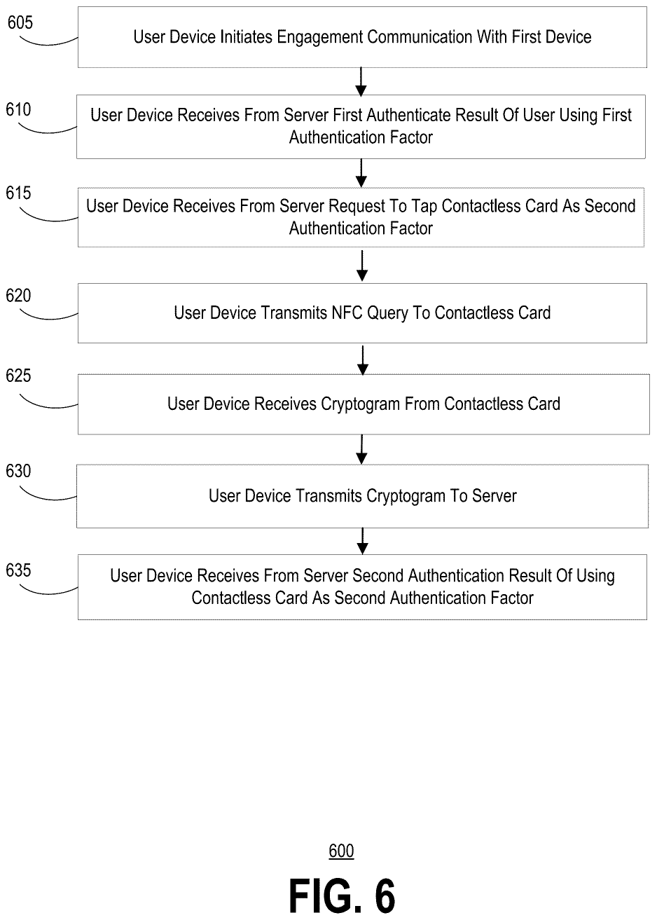

FIG. 6 illustrates a flow chart of an example method 600 for authenticating a user using a contactless card as a second authentication factor for multiple factor authentication according to an example embodiment. FIG. 6 may reference the same or similar components as those illustrated in FIGS. 1-5, including a user device, a server, a database, a first device, and a contactless card. The method 600 can be implemented in the system 100 and may include, but is not limited to the following steps.

The method 600 can be implemented on the user device 120. In step 605, the user device 120 associated with the user initiates an engagement communication with the first device 110. For example, the user from the user device 120 makes a phone call to the first device 110. In step 610, the user device receives from the server 130 a first authenticate result of the user using a first authentication factor. The first authentication factor may be a phone number of the user device 120. The first device 110 can transmit the phone number of the user device 120 to the server 130, and the server 130 can verify the phone number by searching the database 140 for a matching phone number associated with the user. The server 130 can then transmit to the user device the first authenticate result of the user using the first authentication factor. In step 615, the user device 120 receives from the server 130 a request to tap the contactless card as a second authentication factor. For example, the first device 110 requests the server 130 to further authenticate the user using a contactless card as a second authentication factor. The server 130 transmits the second authentication request to the user device 120 for authenticating the user using the contactless card as the second authentication factor. In step 620, the user device 120 transmits a NFC query to the contactless card. After entry of the contactless card into the NFC communication field of the user device 120, the contactless card transmits to the user device 120 NFC response information (e.g., a cryptogram) usable by the server 130 to authenticate the user. Accordingly, in step 625, the user device 120 receives the cryptogram from the contactless card, and then transmits the cryptogram to the server 130 in step 630. When the server 130 verifies the user using the contactless card 160/300 based on the cryptogram as the second authentication factor, the server 130 can transmit to the user device 120 the authentication result of the second authentication factor. Accordingly, in step 635, the user device receives from the server 130 the second authentication result of using the contactless card as the second authentication factor.

In some aspects, the techniques described herein relate to a method for authenticating a user using a contactless card, including: receiving, by a server from a first device, a first request to authenticate the user using a first authentication factor; authenticating, by the server, the user using the first authentication factor; transmitting, by the server to the first device, a first authentication result indicating authentication of the user using the first authentication factor; receiving, by the server from the first device, a second request to authenticate the user using the contactless card; transmitting, by the server to a user device associated with the user, the second request in a message format; receiving, by the server from the user device, a cryptogram; decrypting, by the server, the cryptogram; extracting, by the server, from the decrypted cryptogram a unique customer identifier associated with the contactless card; verifying, by the server, the unique customer identifier; authenticating, by the server, the user using the unique customer identifier; and transmitting, by the server to the first device, a second authentication result indicating authentication of the user using the contactless card.

In some aspects, the techniques described herein relate to a method, wherein the first authentication factor includes at least one selected from the group of a name of the user, a phone number of the user, a home address of the user, a login credential, a biometric identification of the user, and a photo identification of the user.

In some aspects, the techniques described herein relate to a method, wherein the first device includes at least one selected from the group of a customer call center device, an interactive voice response device, an online website hosting device, and an automated teller machine (ATM), a computer in a financial branch, and a kiosk machine.

In some aspects, the techniques described herein relate to a method, wherein the message format includes at least one selected from the group of a short message service (SMS) message with a deeplink, a mobile application notification, a push notification, and an email.

In some aspects, the techniques described herein relate to a method, wherein the user device includes at least one selected from the group of a mobile device having a mobile application installed thereon configured for reading the contactless card, a computer tablet configured for reading the contactless card, an ATM configured for reading the contactless card, a computer in a financial branch configured for reading the contactless card, and a kiosk machine configured for reading the contactless card.

In some aspects, the techniques described herein relate to a method, wherein the contactless card includes a processor and a memory, the memory storing the cryptogram that contains the unique customer identifier.

In some aspects, the techniques described herein relate to a method, wherein: the memory of the contactless card further contains a counter value and a key, and the processor of the contactless card is configured to generate the cryptogram using the counter value, the key, and the unique customer identifier.

In some aspects, the techniques described herein relate to a method, wherein the processor of the contactless card is configured to update the counter value.

In some aspects, the techniques described herein relate to a system for authenticating a user using a contactless card, including a server, the server configured to: receive, from a first device, a first request to authenticate the user using a first authentication factor; authenticate the user using the first authentication factor; transmit, to the first device, a first authentication result indicating authentication of the user using the first authentication factor; receive, from the first device, a second request to authenticate the user using the contactless card; transmit, to a user device associated with the user, the second request in a message format; receive, from the user device, a cryptogram; decrypt the cryptogram; extract from the decrypted cryptogram a unique customer identifier associated with the contactless card; verify the unique customer identifier; authenticate the user using the unique customer identifier; and transmit, to the first device, a second authentication result indicating authentication of the user using the contactless card.

In some aspects, the techniques described herein relate to a system, wherein the first authentication factor includes at least one selected from the group of a name of the user, a phone number of the user, a home address of the user, a login credential, a biometric identification of the user, and a photo identification of the user.

In some aspects, the techniques described herein relate to a system, wherein the first device includes at least one selected from the group of a customer call center device, an interactive voice response device, an online website hosting device, and an automated teller machine (ATM), a computer in a financial branch, and a kiosk machine.

In some aspects, the techniques described herein relate to a system, wherein the message format includes at least one selected from the group of a short message service (SMS) message with a deeplink, a mobile application notification, a push notification, and an email.

In some aspects, the techniques described herein relate to a system, wherein the user device includes at least one selected from the group of a mobile device having a mobile application installed thereon configured for reading the contactless card, a computer tablet configured for reading the contactless card, an ATM configured for reading the contactless card, a computer in a financial branch configured for reading the contactless card, and a kiosk machine configured for reading the contactless card.

In some aspects, the techniques described herein relate to a system, wherein the contactless card includes a processor and a memory, the memory storing the cryptogram that contains the unique customer identifier.

In some aspects, the techniques described herein relate to a system, wherein: the memory of the contactless card further contains a counter value and a key, and the processor of the contactless card is configured to generate the cryptogram using the counter value, the key, and the unique customer identifier.

In some aspects, the techniques described herein relate to a system, wherein the processor of the contactless card is configured to update the counter value.

In some aspects, the techniques described herein relate to a non-transitory, computer-readable medium including instructions for authenticating a user using a contactless card that, when executed on a computer arrangement, perform actions including: receiving, from a first device, a first request to authenticate the user using a first authentication factor; authenticating the user using the first authentication factor; transmitting, to the first device, a first authentication result indicating authentication of the user using the first authentication factor; receiving, from the first device, a second request to authenticate the user using the contactless card; transmitting, to a user device associated with the user, the second request in a message format; receiving, from the user device, a cryptogram; decrypting the cryptogram; extracting from the decrypted cryptogram a unique customer identifier associated with the contactless card; verifying the unique customer identifier; authenticating the user using the unique customer identifier; and transmitting, to the first device, a second authentication result indicating authentication of the user using the contactless card.

In some aspects, the techniques described herein relate to a non-transitory, computer-readable medium, wherein the first authentication factor includes at least one selected from the group of a name of the user, a phone number of the user, a home address of the user, a login credential, a biometric identification of the user, and a photo identification of the user.

In some aspects, the techniques described herein relate to a non-transitory, computer-readable medium, wherein the message format includes at least one selected from the group of a short message service (SMS) message with a deeplink, a mobile application notification, a push notification, and an email.

In some aspects, the techniques described herein relate to a non-transitory, computer-readable medium, wherein the contactless card includes a processor and a memory, the memory storing the cryptogram that contains the unique customer identifier.

Throughout the disclosure, the term merchant is used, and it is understood that the present disclosure is not limited to a particular merchant or type of merchant. Rather, the present disclosure includes any type of merchant, vendor, or other entity involving in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a server from a first device, a first request to authenticate a user using a contactless card;
transmitting, by the server to a user device associated with the user, the first request;
receiving, by the server from the user device, encrypted data;
transmitting, by the server to a card authentication module, the encrypted data;
receiving, by the card authentication module from the server, the encrypted data;
decrypting, by the card authentication module, the encrypted data;
extracting, by the card authentication module, from the decrypted data a unique customer identifier associated with the contactless card;
outputting, by the card authentication module to the server, the unique customer identifier;
receiving, by the server from the card authentication module, the unique customer identifier; and
authenticating, by the server, the user using the unique customer identifier.

2. The method of claim 1, wherein the first device comprises at least one selected from a group consisting of a customer call center device, an interactive voice response device, an online website hosting device, and an automated teller machine (ATM), a computer in a financial branch, and a kiosk machine.

3. The method of claim 1, wherein:
the first request is transmitted to the user device in a message format, and
the message format comprises at least one selected from a group consisting of a short message service (SMS) message with a deeplink, a mobile application notification, a push notification, and an email.

4. The method of claim 1, wherein the user device comprises at least one selected from a group consisting of a mobile device having a mobile application installed thereon configured for reading the contactless card, a computer tablet configured for reading the contactless card, an ATM configured for reading the contactless card, a computer in a financial branch configured for reading the contactless card, and a kiosk machine configured for reading the contactless card.

5. The method of claim 1, wherein the first request to authenticate the user includes at least one selected from a group consisting of a login credential and a phone number associated with the user device.

6. The method of claim 1, further comprising:
transmitting, by the server to the user device, a second request for authentication;
receiving, by the server from the user device, a second authentication factor; and
verifying, by the server, the second authentication factor.

7. The method of claim 1, wherein the encrypted data is generated by the contactless card and transmitted to the user device.

8. The method of claim 7, wherein:
the first request transmitted to the user device includes a link to query the contactless card, and
selecting the link causes the user device to establish a communication with the contactless card and query the contactless card for the encrypted data.

9. A system for authenticating a user using a contactless card, comprising:
a server; and
a card authentication module,
wherein the server is configured to:
receive, from a first device, a first request to authenticate a user using a contactless card,
transmit, to a user device associated with the user, the first request,
receive, from the user device, encrypted data, and
transmit, to the card authentication module, the encrypted data;
wherein the card authentication module is configured to:
receive, from the server, the encrypted data,
decrypt the encrypted data,
extract from the decrypted data a unique customer identifier associated with the contactless card, and
output, to the server, the unique customer identifier; and
wherein the server is further configured to:
receive, from the card authentication module, the unique customer identifier,
and
authenticate the user using the unique customer identifier.

10. The system of claim 9, wherein the server is further configured to transmit, to the first device, an authentication result based on the unique customer identifier.

11. The system of claim 9, wherein:
the encrypted data comprises a cryptogram, and
the card authentication module is configured to decrypt the cryptogram.

12. The system of claim 9, wherein:
the contactless card comprises a processor and a memory, and
the memory stores the encrypted data that contains the unique customer identifier.

13. The system of claim 12, wherein:
the memory of the contactless card further contains a counter value and a key, and
the processor of the contactless card is configured to generate the encrypted data using the counter value, the key, and the unique customer identifier.

14. The system of claim 9, wherein the first device comprises at least one selected from a group consisting of a customer call center device, an interactive voice response device, an online website hosting device, and an automated teller machine (ATM), a computer in a financial branch, and a kiosk machine.

15. The system of claim 9, wherein:
the first request is transmitted to the user device in a message format, and
the message format comprises at least one selected from a group consisting of a short message service (SMS) message with a deeplink, a mobile application notification, a push notification, and an email.

16. The system of claim 9, wherein the user device comprises at least one selected from a group consisting of a mobile device having a mobile application installed thereon configured for reading the contactless card, a computer tablet configured for reading the contactless card, an ATM configured for reading the contactless card, a computer in a financial branch configured for reading the contactless card, and a kiosk machine configured for reading the contactless card.

17. A non-transitory, computer-readable medium comprising instructions for authenticating a user using a contactless card that, when executed on a computer arrangement, perform actions comprising:
receiving, from a first device, a first request to authenticate a user using a contactless card;
transmitting, to a user device associated with the user, the first request;
receiving, from the user device, encrypted data;
decrypting the encrypted data;
extracting from the decrypted data a unique customer identifier associated with the contactless card; and
authenticating the user using the unique customer identifier.

18. The non-transitory, computer-readable medium of claim 17, wherein the first request transmitted to the user device causes the user device to establish a communication with the contactless card and query the contactless card for the encrypted data.

19. The non-transitory, computer-readable medium of claim 17, wherein the instructions further cause the computer arrangement to:
transmit, to the user device, a second request for authentication;
receive, from the user device, a second authentication factor; and
verify the second authentication factor.

20. The non-transitory, computer-readable medium of claim 17, wherein the first device comprises at least one selected from a group consisting of a customer call center device, an interactive voice response device, an online website hosting device, and an automated teller machine (ATM), a computer in a financial branch, and a kiosk machine.
